(19) United States
(12) Patent Application Publication
(10) Pub. No.: US 2025/0019114 A1
(43) Pub. Date: Jan. 16, 2025

(54) Tray For Food Products

(71) Applicant: Graphic Packaging International, LLC, Atlanta, GA (US)

(72) Inventor: Greg Gungner, Cobourg (CA)

(21) Appl. No.: 18/769,574

(22) Filed: Jul. 11, 2024

Related U.S. Application Data
(60) Provisional application No. 63/526,242, filed on Jul. 12, 2023.

(51) Int. Cl. B65D 5/50; B31B 50/26; B65D 5/20; B65D 5/28

(52) U.S. Cl. CPC B65D 5/5021; B31B 50/26; B65D 5/2047; B65D 5/2057; B65D 5/28

(57) ABSTRACT

A tray for holding one or more food products includes a base at least partially extending around an interior of the tray, the base including a base bottom panel, at least one base side panel, a base back panel, and a base front panel, a lid foldably connected to the base, the lid including a top panel, at least one lid side panel, a lid back panel, and a lid front panel, and accessory support features for supporting at least one accessory for one or more food products in the interior of the tray, the accessory support features including at least one accessory support panel foldably connected to base front panel forming at least one accessory compartment in the interior of the tray for at least partially receiving the at least one accessory.

### CROSS-REFERENCE TO RELATED APPLICATION

The present application claims the benefit of and priority to U.S. Provisional Patent Application No. 63/526,242, filed on Jul. 12, 2023.

### INCORPORATION BY REFERENCE

The disclosure of U.S. Provisional Patent Application No. 63/526,242, filed on Jul. 12, 2023, is hereby incorporated by reference for all purposes as if set forth in its entirety.

### BACKGROUND OF THE DISCLOSURE

The present disclosure generally relates to trays for holding one or more food products. In some embodiments, the present disclosure relates to trays for holding one or more food products that include accessory support features for at least partially supporting at least one accessory in an interior of the tray.

### SUMMARY OF THE DISCLOSURE

According to one aspect, the disclosure is generally directed to a tray for holding one or more food products, the tray comprising a base at least partially extending around an interior of the tray, the base comprising a base bottom panel, at least one base side panel, a base back panel, and a base front panel, a lid foldably connected to the base, the lid comprising a top panel, at least one lid side panel, a lid back panel, and a lid front panel, and accessory support features for supporting at least one accessory for one or more food products in the interior of the tray, the accessory support features comprising at least one accessory support panel foldably connected to base front panel for forming at least one accessory compartment in the interior of the tray for at least partially receiving the at least one accessory.

According to another aspect, the disclosure is generally directed to a blank for forming a tray for holding one or more food products, the blank comprising a base portion for at least partially extending around an interior of the tray formed from the blank, the base portion comprising a base bottom panel, at least one base side panel, a base back panel, and a base front panel, a lid portion foldably connected to the base portion, the lid portion comprising a top panel, at least one lid side panel, a lid back panel, and a lid front panel, and accessory support features for supporting at least one accessory for one or more food products in the interior of the tray formed from the blank, the accessory support features comprising at least one accessory support panel foldably connected to base front panel for forming at least one accessory compartment in the interior of the tray for at least partially receiving the at least one accessory.

According to another aspect, the disclosure is generally directed to a method of forming a tray for holding one or more food products, the method comprising obtaining a blank, the blank comprising a base portion comprising a base bottom panel, at least one base side panel, a base back panel, and a base front panel, a lid portion foldably connected to the base portion, the lid portion comprising a top panel, at least one lid side panel, a lid back panel, and a lid front panel, and accessory support features comprising at least one accessory support panel foldably connected to base front panel, forming a base of the tray from the base portion of the blank, the base of the tray extending at least partially around the interior of the tray, forming a lid of the tray from the lid portion of the blank such that the lid is foldably connected to the base, and positioning the at least one accessory support panel to at least partially form at least one accessory compartment in the interior of the tray.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank used to form a tray for holding one or more food products according to an exemplary embodiment of the disclosure.

FIG. 2 is a perspective view of a tray formed from the blank of FIG. 1 in an open configuration according to an exemplary embodiment of the disclosure.

FIG. 3 is a perspective view of a tray formed from the blank of FIG. 1 in an open configuration and including accessories held therein according to an exemplary embodiment of the disclosure.

FIG. 4 is a perspective view of the tray of FIG. 3 with accessories in a closed configuration according to an exemplary embodiment of the disclosure.

Corresponding parts are designated by corresponding reference numbers throughout the drawings.

### DETAILED DESCRIPTION OF THE EXEMPLARY EMBODIMENTS

Trays according to the present disclosure can accommodate articles of numerous different shapes. For the purpose of illustration and not for the purpose of limiting the scope of the disclosure, the following detailed description describes articles such as food products that may be provided in discrete portions, for example, chicken nuggets, chicken strips, French fries, chips, and/or other food items that can commonly be referred to as finger foods. Such food products can also include sandwiches or the like, for example, chicken sandwiches, hamburgers, tacos, burritos, etc. Other types of articles that can include food products and/or nonfood products can be placed in the tray for service to a customer without departing from the disclosure.

In some embodiments, food products can be provided in packaging made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; composite materials; and the like, or any combination thereof.

In this specification, the terms “lower,” “bottom,” “upper,” and “top” indicate orientations determined in relation to fully erected and upright trays. As described herein, trays can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

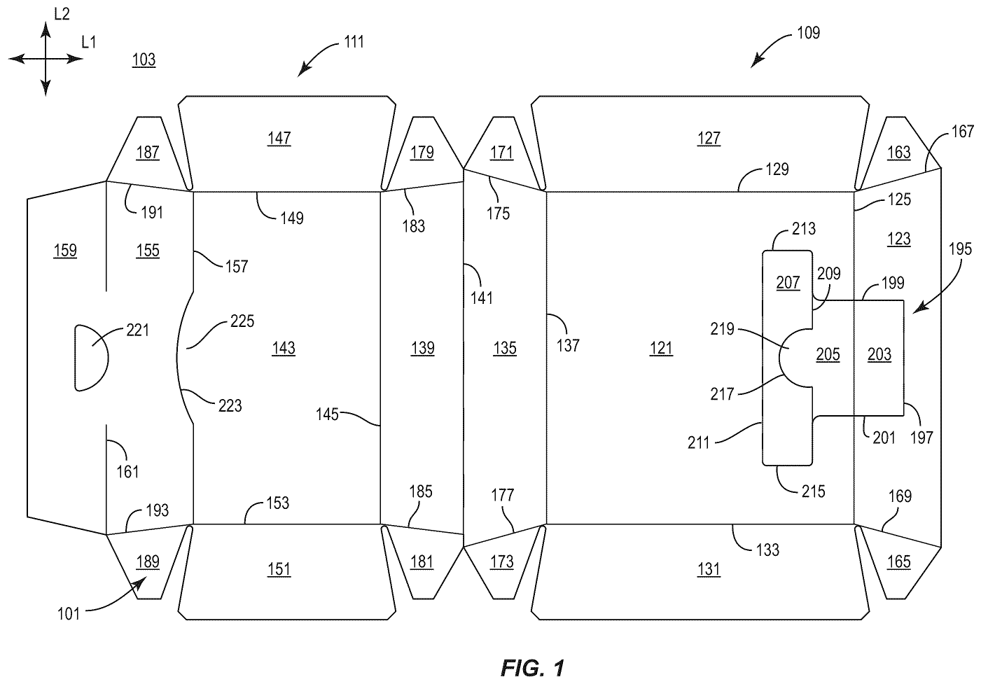

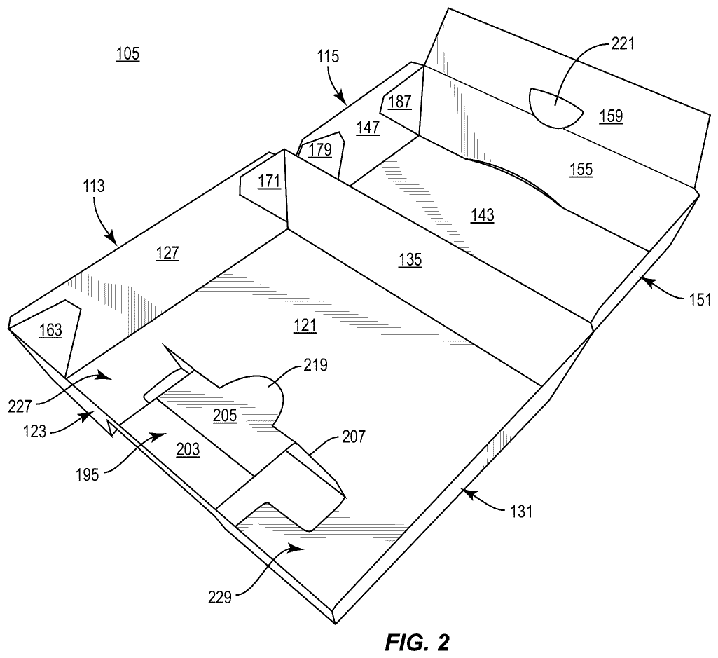

FIG. 1 is a plan view of an exterior surface 101 of a blank, generally indicated at 103, used to form a container assembly or tray 105 (FIG. 2) according to an exemplary embodiment of the disclosure.

As shown, the blank 103 has a longitudinal axis L1 and a lateral axis L2 and includes a base portion 109 for forming a base 113 of the tray 105, and a lid portion 111 for forming a lid 115 of the tray 105. In this regard, the lid portion 111 of the blank 103 is foldably connected to the base portion 109 of the blank 103 such that the lid 115 of the tray 105 is foldably connected to the base 113 of the tray 105 at a fold line 141, as described further herein.

The blank 103 includes plurality of panels for extending at least partially around an interior 107 of the tray 105 when the tray 105 is formed from the blank 103. The panels can include a base bottom panel 121, a base front panel 123 foldably connected to the base bottom panel 121 at a lateral fold line 125, a base first side panel 127 foldably connected to the base bottom panel 121 at a longitudinal fold line 129, a base second side panel 131 foldably connected to the base bottom panel 121 at a longitudinal fold line 133, a base back panel 135 foldably connected to the base bottom panel 121 at a lateral fold line 137, a lid back panel 139 foldably connected to the base back panel 135 at the lateral fold line 141, a lid top panel 143 foldably connected to the lid back panel 139 at a lateral fold line 145, a lid first side panel 147 foldably connected to the lid top panel 143 at a longitudinal fold line 149, a lid second side panel 151 foldably connected to the lid top panel 143 at a longitudinal fold line 153, a lid front panel 155 foldably connected to the lid top panel 143 at a lateral fold line 157, and a lid bottom panel 159 foldably connected to the lid front panel 155 at a lateral fold line 161.

The blank 103 and the tray 105 formed therefrom can also include a plurality of end flaps foldably connected to a respective panel of the plurality of panels. As shown, the plurality of end flaps can include attachment end flaps 163, 165 foldably connected to the base front panel 123 at respective oblique fold lines 167, 169, attachment end flaps 171, 173 foldably connected to the base back panel 135 at respective oblique fold lines 175, 177, attachment end flaps 179, 181 foldably connected to the lid back panel 139 at respective oblique fold lines 183, 185, and attachment end flaps 187, 189 foldably connected to the lid front panel 155 at respective oblique fold lines 191, 193.

In the illustrated embodiment, the base portion 109 of the blank 103 can include the panels 121, 123, 127, 131, 135 and associated end flaps, and the lid portion 111 of the blank 103 can include the panels 139, 143, 147, 151, 155, 159, and associated end flaps, though it will be understood that the base portion 109 and lid portion 111 of the blank 103 can be differently arranged without departing from the disclosure.

As described herein, the interior 107 of the tray 105 is generally formed by the base 113 extending therearound. However, it will be understood that the interior 107 of the tray 105 can include additional space at least partially defined by the lid 115, for example, when the tray 105 is in a closed configuration.

The blank 103 and the tray 105 formed therefrom can also include accessory supporting features for at least partially supporting at least one accessory in the interior 107 of the tray 105. The accessory supporting features can include a first accessory supporting panel 195 foldably connected to the base front panel 123 at a lateral fold line 197 and separably connected to respective portions of the base front panel 123 and the base bottom panel 121 at respective cuts 199, 201 extending from endpoints of the fold line 197 into the base bottom panel 121 such that the cuts 199, 201 interrupt the fold line 125. In this regard, the first accessory supporting panel 195 is at least partially bisected by a portion of the fold line 125 so as to include a first portion 203 foldably connected to the base front panel 123 at the fold line 197, and a second portion 205 foldably connected to the first portion 203 at a respective portion of the fold line 125.

As shown, the accessory supporting features can also include a second accessory supporting panel 207 foldably connected to the second portion 205 of the first accessory supporting panel 195 at a lateral fold line 209, and foldably connected to the base bottom panel 121 at a lateral fold line 211. A respective pair of L-shaped cuts 213, 215 extend from a respective endpoint of the fold line 211 to a respective endpoint of the fold line 209.

The blank 103 and the tray 105 formed therefrom can also include locking features for at least partially maintaining the tray 105 in a closed configuration and the lid 115 in a closed position, as described further herein. Such locking features can include a curved locking cut 217 interrupting the fold line 209 so as to define a locking tab 219 protruding from the remainder of the second portion 205 of the first accessory supporting panel 195. The locking features can further include a generally semicircular locking opening 221 positioned along an interruption in the fold line 161 and at least partially defined in the lid bottom panel 159 for at least partially receiving the locking tab 219, as described further herein.

Further, the blank 103 and tray 105 formed therefrom can include a user engagement tab 225 protruding from the remainder of the lid top panel 143 and at least partially defined by a curved cut 223 interrupting the fold line 157. As described further herein, the user engagement tab 225 can be provided to facilitate reconfiguration of the tray 105 between an open configuration and a closed configuration.

Referring additionally to FIG. 2-4, formation of the tray 105 from the blank 103 according to some exemplary embodiments of the disclosure will be described.

In order to form the base 113 of the tray 105, the panels 123, 127, 131, 135 can be at least partially folded at the respective fold lines 125, 129, 133, 137 into a generally upright position relative to the bottom panel 121 such that the panels 123, 127, 131, 135 are positioned extending at least partially around the interior 107 of the tray 105.

The end flaps 163, 171 can be folded at the respective fold lines 167, 175 into at least partial face-to-face contact with the panel 127, and the end flaps 165, 173 can be folded at the respective fold lines 169, 177 into at least partial face-to-face contact with the panel 131.

The accessory support features can be activated, in some embodiments, by at least partially separating the portions 203, 205 of the first accessory support panel 195 from the panels 121, 123 at respective portions of the cuts 199, 201, and folding the first accessory support panel 195/first portion 203 at the fold line 197 to position the first accessory support panel 191 in generally spaced and parallel relation to the base bottom panel 121.

In some embodiments, such movement of the first accessory support panel 195 can include relative movement of the portions 203, 205 thereof via folding at the respective portion of the fold line 125. It will be understood that one or more portions of the first accessory panel 195 can be positioned obliquely relative to the base bottom panel 121 without departing from the disclosure.

The second accessory support panel 207 can also be folded downwardly relative to the first accessory support panel 195/second portion 205 thereof at the fold line 209 such that respective portions of the panels 121, 127, 123, 195, 207 extend at least partially around a first accessory compartment 227 in the interior 107 of the tray 105, and such that respective portions of the panels 121, 131, 123, 195, 207 extend at least partially around a second accessory compartment 229 in the interior 107 of the tray 105.

Accordingly, the first accessory compartment 227 can be at least partially defined between the bottom panel 121, the base side panel 127, the base front panel 123, and the first accessory support panel 195, and the second accessory compartment 229 an be at least partially defined between the bottom panel 121, the base side panel 131, the base front panel 123, and the first accessory support panel 195

Such movement of the second accessory support panel 207 can also cause the locking tab 219 to at least partially separate therefrom at the cut 217 such that the locking tab 219 is positioned extending away from a free edge of the remainder of the first accessory support panel 195.

To form the lid 115 of the tray 105, according to some exemplary embodiments, the lid top panel 143 can be at least partially folded relative to the lid back panel 139 at the fold line 145, the panels 147, 151, 155 can be folded at the respective fold lines 149, 153, 157 into generally downward relation relative to the lid top panel 143, the end flaps 179, 187 can be folded at the respective fold lines 183, 191 into at least partial face-to-face contact with respective portions of the panel 147, and the end flaps 181, 189 can be folded at the respective fold lines 185, 193 into at least partial face-to-face contact with respective portions of the panel 151.

The panel 159 can be further folded at the fold line 161 into generally spaced and parallel relation with the lid top panel 143. In some embodiments, the panel 159 can be maintained in generally coplanar relation with the lid front panel 155.

The aforementioned folding of the panel 155 can cause at least partial separation of the user engagement tab 225 therefrom at the cut 223, such that the user engagement tab 225 is positioned protruding from a free edge of the remainder of the lid top panel 143.

It will be understood that the aforementioned arrangement of the tray 105 can be at least partially maintained via one or more applications of an adhesive such as glue. In some embodiments, an adhesive can be applied to one or more surfaces of one or more of the attachment end flaps 163, 165, 171, 173, 179, 181, 187, 189.

The tray 105 erected from the blank 103, as described above or through an alternative sequence of formation, provides a lid 115 foldably connected to a base 113 at the fold line 141. As described herein, the tray 105 is reconfigurable between an open configuration, in which the lid 115 is in an open position at least partially raised away from the base 113 of the tray 105, and a closed configuration, in which the lid 115 is in a closed position at least partially overlying the base 113 and/or interior 107 of the tray 105. In some embodiments, the closed configuration of the tray 105/closed position of the lid 115 can include contact between one or more of the panels 143, 147, 151, 155, 159 and a respective portion of the base 113 of the tray 105.

In addition, a portion of the base 113 can protrude forwardly from the lid 115, e.g., from the lid front panel 155. In this regard, at least the portion of the base 113 that at least partially forms the accessory compartments 227, 229 can be exposed forwardly and below the lid 115 so as to be spaced away from the lid 115 in each of the open configuration of the tray 105 and the closed configuration of the tray 105.

In some embodiments, the accessory compartments 227, 229 can be respective first and second compartments of the interior 107 of the tray 105, and the remainder of the interior 107 of the tray 105, e.g., that portion which is coextensive with the lid 115, can be a third compartment of the interior 107 of the tray 105. In other embodiments, the accessory compartments 221, 223 can be considered separate from the interior 107 of the tray 105, e.g., such that the interior 107 of the tray 105 which is coextensive with the lid 115.

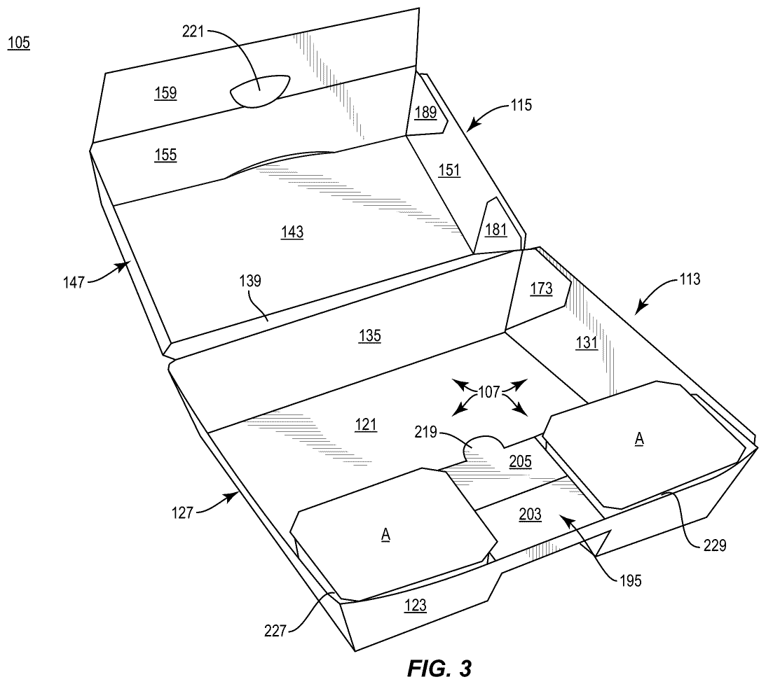

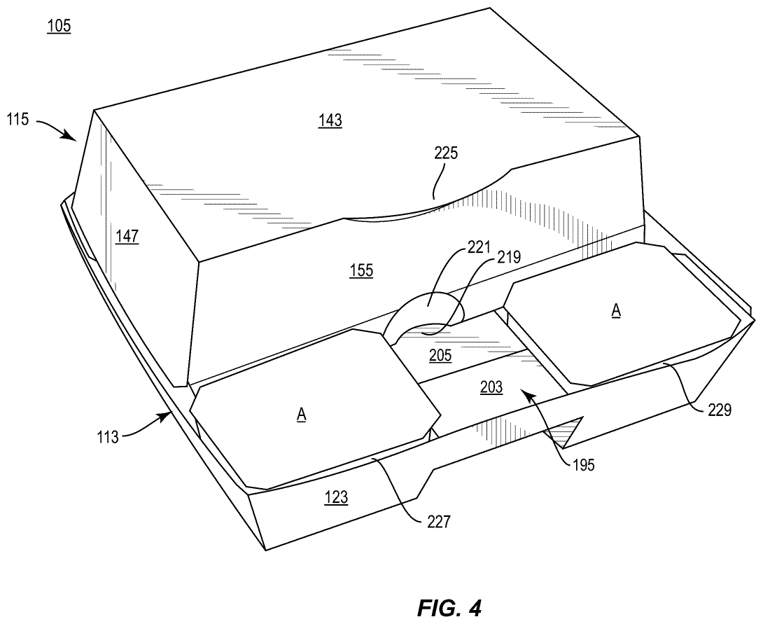

As shown in FIGS. 3 and 4, one or both of a pair of accessories A can be at least partially received in the accessory compartments 227, 229 so as to be readily accessible to a user, and partitioned from the remainder of the interior 107 of the tray 105 in which one of more food products such as chicken nuggets, chicken strips, French fries, chips, sandwiches or the like, for example, chicken sandwiches, hamburgers, tacos, burritos, etc., can be placed during or following erection of the tray 105. Accordingly, one or both of the accessories A can be, but are not limited to, dressings or dips related to a food product, for example, a sauce or dressing (e.g., ketchup, mustard, barbeque sauce, dip, ranch dressing, hot sauce, etc.) and/or another condiment.

In some embodiments, a rim or flange extending outwardly from the accessory A can rest upon one or more portions of the accessory support panel 195, an upper edge of the base front panel 123, and/or an upper edge of a respective base side panel 127, 131. In this regard, the respective accessory A provides a user with convenient and stabilized access to its contents, for example, such that a food product can be dipped therein and/or such that the accessory A can be removed from the respective accessory compartment 227, 229 to be applied to the food product.

FIG. 4 illustrates the closed configuration of the tray 105, in which the lid 115 is in the closed position. In order to at least partially maintain the closed configuration of the tray 105, the locking features can be activated such that the locking tab 219 is at least partially received in the locking opening 221.

In order to transition the tray 105 to the open configuration, the locking tab 219 can be disengaged, e.g., withdrawn, from the locking opening 221, and the lid back panel 139 can be folded relative to the base back panel 135 such that the lid 115 is folded about the fold line 141 upwardly and away from the interior 107 of the tray 105.

To effect such reconfiguration of the tray 105, in some embodiments, a user can press on a portion of the lid front panel 155 so as to cause bending/flexion thereof to more the locking opening 221 rearwardly and out of engagement with the locking tab 219. Simultaneously or thereafter, the user can lift the lid 115, for example, at the user engagement tab 225, to cause folding thereof relative to the base 113 at the fold line 141.

In the open configuration of the tray 105, full access to the contents of the interior 107 can be provided, for example, for display, during service, during eating, etc.

In order to reconfigure the tray from the open configuration to the closed configuration, the lid 115 can be pressed and/or carried at least partially downwardly to cause the lid 115 to fold about the fold line 141 into an at least partially overlapping/covering position over the portion of the interior 107 of the tray 105 rearwardly of the accessory compartments 227, 229.

In order to lock the tray 105 in the closed configuration, for example, to prevent inadvertent opening thereof, for storage, to maintain freshness, etc., the lid 115 can be pressed to a point at which the locking tab 219 at least partially cams over the lid front panel 155 until it is at least partially received in the locking opening 221.

It will be understood that one or more portions of the tray 105 can have a different configuration without departing from the disclosure.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the trays, to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure tray panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding one or more food products, the tray comprising:
a base at least partially extending around an interior of the tray, the base comprising a base bottom panel, at least one base side panel, a base back panel, and a base front panel;
a lid foldably connected to the base, the lid comprising a top panel, at least one lid side panel, a lid back panel, and a lid front panel; and
accessory support features for supporting at least one accessory for one or more food products in the interior of the tray, the accessory support features comprising at least one accessory support panel foldably connected to base front panel and forming at least one accessory compartment in the interior of the tray for at least partially receiving the at least one accessory.

2. The tray of claim 1, wherein the at least one accessory compartment is at least partially defined between the base bottom panel, the at least one accessory panel, the base front panel, and the at least one base side panel.

3. The tray of claim 2, wherein the at least one accessory support panel is separated from each of the base front panel and the base bottom panel.

4. The tray of claim 3, wherein the at least one accessory support panel is a first accessory support panel foldably connected to the base front panel, and the accessory support features further comprise a second accessory support panel foldably connected to each of the first accessory support panel and the base bottom panel.

5. The tray of claim 4, wherein the first accessory support panel comprises a first portion foldably connected to the base front panel and a second portion foldably connected to each of the first portion and the second accessory support panel.

6. The tray of claim 5, wherein the base bottom panel is foldably connected to the base front panel at a fold line, and the first accessory support panel is separated from each of the base front panel and the base bottom panel at at least one cut that interrupts the fold line.

7. The tray of claim 6, further comprising locking features, the locking features comprising a locking tab extending from the first accessory support panel and a locking opening at least partially defined in the lid.

8. The tray of claim 7, wherein the tray is reconfigurable between a first configuration, in which the lid at least partially overlies the interior of the tray, and a second configuration, in which the lid is raised away from the interior of the tray, the locking opening is for at least partially receiving the locking tab for maintaining the tray in the closed configuration.

9. The tray of claim 8, wherein the at least one accessory compartment is positioned spaced away from the lid in each of the open configuration of the tray and the closed configuration of the tray.

10. The tray of claim 9, wherein the at least one base side panel is a first base side panel and the base further comprises a second base side panel, the at least one lid side panel is a first lid side panel and the lid further comprises a second lid side panel and a lid bottom panel, the locking opening at least partially defined in the lid bottom panel, and the lid back panel is foldably connected to the base back panel.

11. The tray of claim 10, wherein the at least one accessory compartment is a first accessory compartment at least partially defined between the base bottom panel, the first accessory panel, the base front panel, and the first base side panel, and the accessory support features further comprise a second accessory compartment at least partially defined between the base bottom panel, the first accessory panel, the base front panel, and the second base side panel.

12. The tray of claim 11, wherein a user engagement tab extends from the lid top panel.

13. A blank for forming a tray for holding one or more food products, the blank comprising:
a base portion for at least partially extending around an interior of the tray formed from the blank, the base portion comprising a base bottom panel, at least one base side panel, a base back panel, and a base front panel;
a lid portion foldably connected to the base portion, the lid portion comprising a top panel, at least one lid side panel, a lid back panel, and a lid front panel; and
accessory support features for supporting at least one accessory for one or more food products in the interior of the tray formed from the blank, the accessory support features comprising at least one accessory support panel foldably connected to base front panel for forming at least one accessory compartment in the interior of the tray for at least partially receiving the at least one accessory.

14. The blank of claim 13, wherein the at least one accessory support panel is separably connected to each of the base front panel and the base bottom panel.

15. The blank of claim 14, wherein the at least one accessory support panel is a first accessory support panel foldably connected to the base front panel, and the accessory support features further comprise a second accessory support panel foldably connected to each of the first accessory support panel and the base bottom panel.

16. The blank of claim 15, wherein the first accessory support panel comprises a first portion foldably connected to the base front panel and a second portion foldably connected to each of the first portion and the second accessory support panel.

17. The blank of claim 16, wherein the base bottom panel is foldably connected to the base front panel at a fold line, and the first accessory support panel is separably connected to each of the base front panel and the base bottom panel at at least one cut that interrupts the fold line.

18. The blank of claim 17, further comprising locking features, the locking features comprising a locking tab extending from the first accessory support panel and a locking opening at least partially defined in the lid portion.

19. The blank of claim 18, wherein the at least one base side panel is a first base side panel and the base further comprises a second base side panel, the at least one lid side panel is a first lid side panel and the lid further comprises a second lid side panel and a lid bottom panel, the locking opening at least partially defined in the lid bottom panel, and the lid back panel is foldably connected to the base back panel.

20. The blank of claim 19, wherein a user engagement tab extends from the lid top panel.

21. A method of forming a tray for holding one or more food products, the method comprising:
obtaining a blank, the blank comprising a base portion comprising a base bottom panel, at least one base side panel, a base back panel, and a base front panel, a lid portion foldably connected to the base portion, the lid portion comprising a top panel, at least one lid side panel, a lid back panel, and a lid front panel, and accessory support features comprising at least one accessory support panel foldably connected to base front panel;
forming a base of the tray from the base portion of the blank, the base of the tray extending at least partially around the interior of the tray;
forming a lid of the tray from the lid portion of the blank such that the lid is foldably connected to the base; and
positioning the at least one accessory support panel to at least partially form at least one accessory compartment in the interior of the tray.

22. The method of claim 21, wherein the at least one accessory compartment is at least partially defined between the base bottom panel, the at least one accessory panel, the base front panel, and the at least one base side panel.

23. The method of claim 22, wherein positioning the at least one accessory support panel comprises at least partially separating the at least one accessory support panel from each of the base front panel and the base bottom panel.

24. The method of claim 23, wherein the at least one accessory support panel is a first accessory support panel foldably connected to the base front panel, and the accessory support features further comprise a second accessory support panel foldably connected to each of the first accessory support panel and the base bottom panel.

25. The method of claim 24, wherein the first accessory support panel comprises a first portion foldably connected to the base front panel and a second portion foldably connected to each of the first portion and the second accessory support panel.

26. The method of claim 25, wherein the base bottom panel is foldably connected to the base front panel at a fold line, and the method comprises at least partially separating the first accessory support panel from each of the base front panel and the base bottom panel at at least one cut that interrupts the fold line.

27. The method of claim 26, wherein the blank further comprises locking features, the locking features comprising a locking tab extending from the first accessory support panel and a locking opening at least partially defined in the lid portion.

28. The method of claim 27, wherein the tray is reconfigurable between a first configuration, in which the lid at least partially overlies the interior of the tray, and a second configuration, in which the lid is raised away from the interior of the tray, the locking opening is for at least partially receiving the locking tab for maintaining the tray in the closed configuration.

29. The method of claim 28, wherein the at least one accessory compartment is positioned spaced away from the lid in each of the open configuration of the tray and the closed configuration of the tray.

30. The method of claim 29, wherein the at least one base side panel is a first base side panel and the base further comprises a second base side panel, the at least one lid side panel is a first lid side panel and the lid further comprises a second lid side panel and a lid bottom panel, the locking opening at least partially defined in the lid bottom panel, and the lid back panel is foldably connected to the base back panel.

31. The method of claim 30, wherein the at least one accessory compartment is a first accessory compartment at least partially defined between the base bottom panel, the first accessory panel, the base front panel, and the first base side panel, and the accessory support features further comprise a second accessory compartment at least partially defined between the base bottom panel, the first accessory panel, the base front panel, and the second base side panel.

32. The method of claim 31, wherein a user engagement tab extends from the lid top panel.
